(19) United States
(12) Patent Application Publication
(10) Pub. No.: US 2005/0126668 A1
(43) Pub. Date: Jun. 16, 2005

(54) Post patch for mounting devices inside tires

(76) Inventors: Pierre Fornerod, London (GB); Arthur Richard Metcalf, Greenville, SC (US); Jay Clifford Sinnett, Greenville, SC (US)

Correspondence Address: DORITY & MANNING, P.A., POST OFFICE BOX 1449, GREENVILLE, SC, 29602-1449, US

(21) Appl. No.: 10/737,642

(22) Filed: Dec. 16, 2003

(51) Int. Cl. B60C 23/00

(52) U.S. Cl. 152/152.1; 152/367; 156/123

(57) ABSTRACT

A system, method and apparatus for mounting electrical and electronic components and devices for integration with a pneumatic tire includes a specially configured mounting patch for mounting at least one electronic device supported by a substrate. The mounting patch is preferably adapted for positioning on the inner liner of a pneumatic tire and is configured to decouple any mounted electronic device from tire related phenomena including mechanical stress, vibration, heat, and other adverse effects generated from rotational operation of the tire. Exemplary mounting patches include circular or rectangular platforms for supporting various electronic components and circular, rectangular or cross-shaped pillars coupling the base of the mounting patch to electronic device supporting platform. Selected of the electronic devices may be encapsulated by a potting material to facilitate effective attachment of the electronic devices to the tire patch.

### FIELD OF THE INVENTION

The present invention generally concerns a system, method and apparatus for mounting electrical and electronic components and assemblies in a tire. The subject matter disclosed relates to mounting patches and techniques for mounting power source(s), circuit boards, and other electronic devices on so called “patch” elements within a tire.

### BACKGROUND OF THE INVENTION

The incorporation of electronic devices with and within pneumatic tire structures yields many practical advantages. Tire electronics may include sensors and other components for obtaining information regarding various physical parameters of a tire, such as temperature, pressure, number of tire revolutions, vehicle speed, revolutions at speed, revolutions at temperature, etc. Such performance information may become useful in tire monitoring and warning systems, and may even potentially be employed with feedback systems to regulate proper tire pressure levels.

One of many potential capabilities offered by electronics systems integrated with tire structures is asset tracking and performance characterization for commercial vehicular applications. Commercial truck fleets, aviation crafts and earthmover/mining vehicles are all viable industries that could utilize the benefits of tire electronic systems and related information transmission. Tire sensors can determine the distance each tire in a vehicle has traveled and thus aid in maintenance planning for such commercial systems. Vehicle location and performance can be optimized for more expensive applications such as those concerning earth-mining equipment.

In other potential tire electronics applications, RFID chips can be incorporated with a tire or wheel assembly to identify and characterize a tire over the course of its lifetime. Various sensors may also be incorporated into a tire to monitor associated tire conditions.

One important consideration associated with the incorporation of electronic devices and structures with pneumatic tires resides in the structures and techniques used to mount or attach the various electronic devices and structures to, with and within the pneumatic tire. In most instances it may be important that the electronic device be securely mounted or attached to the tire. In some instances it may be important that the electronic device not only be securely attached but also that the attachment mechanism permits the transmissions of road or surface contact vibrations. In other instances it may be important that the attachment mechanism isolate the electronic device from externally induced vibrations or other undesirable influences.

U.S. Pat. No. 5,877,679 (Prottey) discloses a rectangular sensor attached to the inner liner of a tire by way of four pillars made of a curable adhesive material. The arrangement also includes a link member configured to be in contact with both the inner liner of the tire and the sensor. The configuration provides a mounting arrangement for the sensor such that tire rotation signals may be generated.

U.S. Patent Application Publication No. US 2002/0124934 (Koch et al.) discloses a monitoring device and patch assembly wherein the patch includes a platform portion and electronic device components are secured to the platform portion by encapsulating the electronic device components and at least a portion of the platform portion of the patch in an encapsulating material. The disclosure describes an encapsulating technique wherein the electronic device components ate suspended inside a frame that is either glued to or forcibly held against a patch while an encapsulating material is poured into the frame so that the encapsulating material may flow completely around the electronic device components and thereby secure the electronic device components to the patch.

U.S. Pat. No. 6,388,567 (Bohm et al.) discloses a monitoring device and patch combination used to monitor the conditions of a tire. The patch portion houses an antenna and is securely mounted to the innerliner of a tire. The monitoring portion, which may be separately fabricated from the patch portion, includes sensors and other circuitry to monitor various parameters related to the tire and includes a battery fully encased with the monitoring circuitry.

Another example of a mounting arrangement for an electronic tire monitoring system can be found in U.S. Pat. No. 6,309,494 (Koch et al. '494), which concerns a method of attaching electronic equipment to the inner surface of a tire. The method involves the use of an epoxy adhesive to directly bond the monitoring device to the inner surface of the innerliner of the tire.

Yet another example of a mounting arrangement for an electronic tire monitoring system can be found in U.S. Pat. No. 6,255,940 (Phelan et al.), which discloses another patch and monitoring device combination. The patch portion of the combination includes a nut secured within a central portion of the patch for receiving a matching bolt. The monitoring portion of the combination includes a module containing various sensors, a battery and other circuitry all encased in an epoxy and glass bead mixture. Mounted within this module is a nut, similar to the nut contained within the patch portion, such that the monitoring portion may be attached to the patch portion after the patch portion is securely attached to an inner surface of the tire.

A further example of a mounting arrangement for an electronic tire monitoring system can be found in U.S. Pat. No. 6,087,930 (Kulka et al.) which discloses an active integrated circuit transponder and sensor apparatus all encased in a unitary housing. The monitoring system includes an integral battery and the entire arrangement may be inserted directly within the sidewall of a tire to be monitored or configured as a patch so be secured to an inside surface of the tire to be monitored.

Yet a further example of a mounting arrangement for an electronic tire monitoring system can be found in U.S. Pat. No. 6,030,478 (Koch et al. '478), which discloses a method and apparatus permitting the insertion and removal of an electronic monitoring device from a tire. Such patent discloses a technique wherein a vulcanized rubber patch is permanently assembled to the inner liner of a tire and an electronic monitoring device, which has been encapsulated in a rigid potting material and fitted with a battery, is inserted into a cavity in the patch.

A still further example of a mounting arrangement for an electronic tire monitoring system can be found in U.S. Pat. No. 6,462,650 (Balzer et al.), which discloses a rubber ply affixed to the inside surface of a tire. A retainer assembly is used to secure an electronics module to the rubber ply such that the module is support within the tire's cavity.

The disclosures of all of the foregoing United States patents and the United States patent application are hereby fully incorporated into this application for all purposes by reference thereto.

One concern associated with the use of tire monitoring patch and electronics combinations like those of the above-noted prior art involves the secure attachment of the combinations to the tire. As in the cases of Bohm et al., Phelan et al., Balzer et al., and Koch et al. '478 noted hereinabove, a solution has been provided involving the use of a separate supporting/attachment patch and a physically separate electronics package or module. Alternatively, other solutions to the attachment problem provide unitary devices that may be directly secured to the tire as in Koch et al., '494 and Kulka et al.

A second concern associated with the use of tire monitoring patch and electronics combinations like those of the above-noted prior art is directed to use of relatively complex mechanism(s) to attach the electronics package or module to the supporting patch. The need to support relatively heavy circuitry associated with the electronics portion of the tire monitoring and electronics combination has previously required a physically robust mounting structure such as, for example, the nut and bolt arrangement of Phelan et al. or the overly complex encasement technique of the Koch et al. published application (US 2002/0124934) requiring the use of a casting frame to encase the electronic device and secure it to the patch.

Yet another concern associated with tire monitoring patch and electronics combinations relates to the fact that the patch or mounting portion of the combination must be flexible in order to adapt to the rotational movement of the tire while in use. Because of this required flexibility, care must be taken that the internal connections of the electronic circuitry are not disrupted or impaired due to continual flexing of the patch.

While various tire monitoring patch and electronics systems have been developed, no one design has emerged that generally addresses all of the above-referenced concerns and that encompasses all of the desired characteristics as hereafter presented in accordance with the subject technology.

### SUMMARY OF THE INVENTION

In view of the recognized features addressed by the present subject matter, an improved system and method for mounting devices, such as electronic components, in a tire interior has been developed. Generally, a modular mounting assembly includes an integrated combination of a patch assembly and a tag assembly.

Various features and aspects of the subject modular mounting assemblies and tire electronics applications offer a plurality of advantages. The disclosed modular mounting assembly is provided with significant design versatility since the patch mounting portion can be used to mount a plurality of different devices. Exemplary electronic devices may include such components as condition-responsive devices including transducers, acoustic devices, sensors, etc. for sensing certain environmental conditions such as temperature and/or pressure, tire revolution counters, vehicle speed sensors, sidewall deflection sensors, tire displacement sensors, microprocessors, memory modules, RFID transponders, light assemblies, data transmitters and/or receivers, and power supply components.

Another advantage in accordance with certain embodiments of the present technology lies in providing improved technology for mounting an electronic device on the inside of a tire while decoupling the electronic device from the mechanical stress, vibration, and heat generation associated with the rotation of the tire.

Yet another advantage in accordance with certain embodiments of the presently disclosed technology is that techniques are provided for simplifying the attachment of the electronics portion of the electronics device to the mounting patch. This corresponds in one exemplary embodiment to gluing an encapsulated “tag” assembly directly to a portion of the mounting post followed by encapsulation of the glued, encapsulated tag assembly and a portion of the mounting post. In another exemplary embodiment, an electronic device is potted into a rigid housing that is then directly glued to a portion of the mounting post.

A still further advantage of certain embodiments of the present subject matter is that improved bonding of the tire electronics system is facilitated by providing contoured platforms to fit within the contour of the tag assembly. This corresponds in one exemplary embodiment to the provision of a post platform having an outer contour shaped like the footprint of the tag assembly.

Yet a further advantage of certain embodiments of the present subject matter is that certain vibration transmission modes are suppressed. In one exemplary embodiment of the presently disclosed technology this corresponds to the provision of specifically shaped posts connecting the electronic device supporting platform to the tire inner liner attachment portion of the mounting patch.

Other exemplary embodiments of the present subject matter correspond to a tire assembly including a pneumatic tire and a combined mounting patch and electronics assembly such as referenced above, wherein the mounting patch and electronics assembly is mounted on an inner liner location of the pneumatic tire. Exemplary such locations within the tire may correspond to the internal crown or sidewall locations.

Additional aspects and advantages of the present subject matter are set forth in, or will be apparent to, those of ordinary skill in the art from the detailed description herein. Also, it should be further appreciated that modifications and variations to the specifically illustrated, referred and discussed features and steps hereof may be practiced in various embodiments and uses of the invention without departing from the spirit and scope of the subject matter. Variations may include, but are not limited to, substitution of equivalent means, features, or steps for those illustrated, referenced, or discussed, and the functional, operational, or positional reversal of various parts, features, steps, or the like.

Still further, it is to be understood that different embodiments, as well as different presently preferred embodiments, of the present subject matter may include various combinations or configurations of presently disclosed features, steps, or elements, or their equivalents (including combinations of features, parts, or steps or configurations thereof not expressly shown in the figures or stated in the detailed description of such figures). Additional embodiments of the present subject matter, not necessarily expressed in this summarized section, may include and incorporate various combinations of aspects of features, components, or steps referenced in the summarized objectives above, and/or other features, components, or steps as otherwise discussed in this application. Those of ordinary skill in the art will better appreciate the features and aspects of such embodiments, and others, upon review of the remainder of the specification.

### BRIEF DESCRIPTION OF THE DRAWINGS

A full and enabling disclosure of the present subject matter, including the best mode thereof, directed to one of ordinary skill in the art, is set forth in the specification, which makes reference to the appended figures, in which:

FIG. 1 displays a side view of a first exemplary tire patch structure in accordance with the present subject matter;

FIG. 2 displays a top plan view of a first exemplary embodiment of the tire patch structure such as illustrated in FIG. 1;

FIG. 3 displays a side view of a first exemplary patch assembly embodiment including a tire patch structure as illustrated in FIGS. 1 and 2 with a tag assembly secured thereto;

FIG. 4 displays a side cross-sectional view of an encapsulated tag assembly in accordance with the present subject matter;

FIG. 5 displays a side cross-sectional view of an alternative patch assembly embodiment illustrating an exemplary technique for mounting of a tag assembly to the tire patch structure illustrated in FIG. 1;

FIG. 6 displays a side cross-sectional view of another alternative patch assembly embodiment illustrating an alternative exemplary technique for mounting a tag assembly to the tire patch structure illustrated in FIG. 1;

FIG. 7 displays a side view of a second exemplary patch assembly embodiment in accordance with the present subject matter;

FIG. 8 displays a top plan view of the patch assembly embodiment illustrated in FIG. 7;

FIG. 9 displays a side view of a third exemplary patch assembly embodiment in accordance with the present subject matter;

FIG. 10 displays a top plan view of the patch assembly embodiment illustrated in FIG. 9;

FIG. 11 displays a side view of a fourth exemplary patch assembly embodiment in accordance with the present subject matter;

FIG. 12 displays a top plan view of the patch assembly embodiment illustrated in FIG. 11; and

FIG. 13 displays a cross section of an exemplary pneumatic tire, illustrating alternative mounting locations for the subject patch assemblies.

Repeat use of reference characters throughout the present specification and appended drawings is intended to represent same or analogous features or elements of the invention.

### DETAILED DESCRIPTION OF THE PREFERRED EMBODIMENTS

Reference will now be made in detail to the presently preferred embodiments of the subject matter comprising an improved patch assembly system and method for mounting an electronics assembly within a tire structure. Selected combinations of the aforementioned aspects of the disclosed technology correspond to a plurality of different embodiments of the present subject matter. It should be noted that each of the exemplary embodiments presented and discussed herein should not insinuate limitations of the present subject matter. Features or steps illustrated or described as part of one embodiment may be used in combination with aspects of another embodiment to yield yet further embodiments. Additionally, certain features may be interchanged with similar devices or features not expressly mentioned which perform the same or similar function. Similarly, certain process steps may be interchanged or employed in combination with other steps to yield additional exemplary embodiments of a method for mounting a patch assembly to the interior lining of a tire.

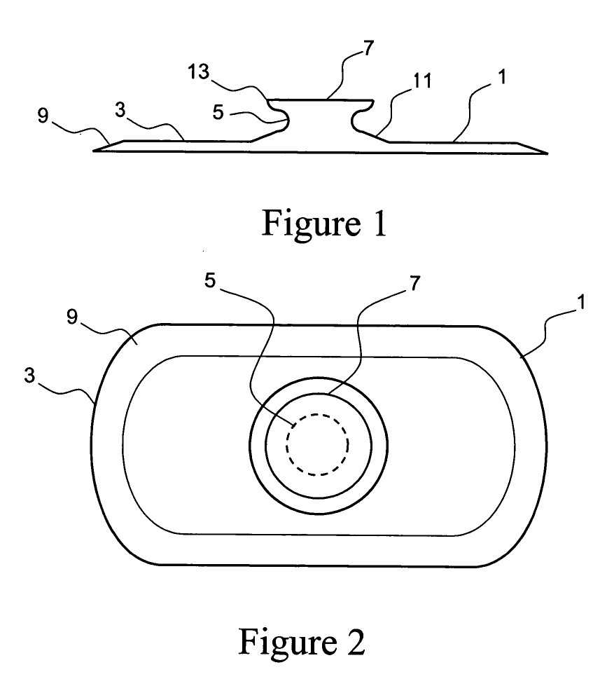

With particular reference to FIGS. 1 and 2, there are illustrated, respectively, side and top views of a first embodiment of a tire patch 1 in accordance with the presently disclosed subject matter. The tire patch 1 is composed of a vulcanized rubber compound and comprises three major components: a base 3 for attachment to the inner liner of a tire, a platform 7 for supporting variously selected electronic components, and a pillar 5 for coupling the base 3 to the platform 7 and providing at least partial isolation or decoupling of any electronic devices which may be mounted on the platform 7 from road and tire induced conditions that may adversely effect electronic devices supported by tire patch 1. In addition to these three major components, several other features of tire patch 1 are significant. Edges 9 of the base 3 may be feathered to avoid stress concentration around the perimeter of the base. The generally oval shape of the base 3, as best seen in FIG. 2, also assists in avoiding stress concentration. The base 3 is relatively thin to allow for bending of the base portion as the tire in which the tire patch 1 may be mounted flattens when it comes in contact with the ground or road surface. A tapered profile 11 is provided for the transition area from the base 3 of the tire patch 1 to the pillar 5 so as to uniformly distribute any stress propagating between any electronic device that may be mounted on the platform 7 and the tire inner liner to which the base 3 may be attached. The pillar 5 is necked down, as best seen in FIG. 1, to an optimum width to support any electronic device that may be mounted on the platform 7. Such configuration also helps to ensure that not too much strain is transmitted through the pillar 5 to the base 3 and, from there, to the inner liner of a tire. Finally, as illustrated in FIG. 1, the edges 13 of the platform are flared to avoid stress concentration at the edge of the platform 7 in a manner similar to the feathering of the edges 9 of the base portion of the tire patch 1. The platform 7 per se is provided with a generally flat, circular shape (as seen in FIGS. 1 and 2) so as to provide a flat surface for bonding to an electronic module which may be positioned on top of the platform 7 and a circular shape so as to provide optimum strength in all directions. Generally, the tire patch 1 is designed to take the maximum force (centrifugal and inertial) generated by any electronic device which may be secured to the platform 7 and distribute the force to a sufficient area of a tire inner liner so as to prevent any damage to the tire and to assure good adhesion of the tire patch 1 to a tire inner liner using available rubber-to-rubber bonding techniques.

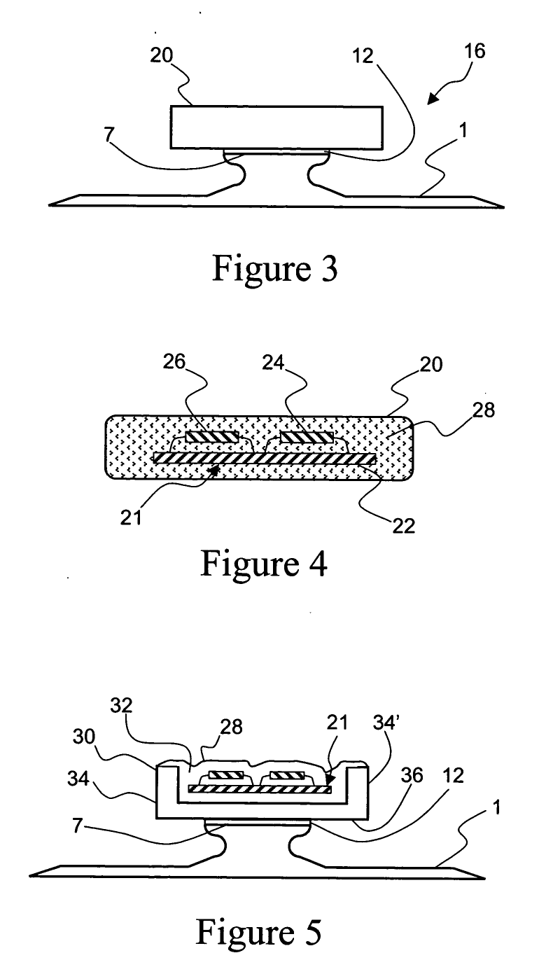

With reference to FIG. 3, there is illustrated an encapsulated tag assembly 20, as will presently be more fully described, secured to the mounting platform 7 of tire patch 1. Such integrated combination of tag assembly 20 and tire patch 1 yields an exemplary patch assembly 16.

The tag assembly 20 of patch assembly 16 will now be more fully described with reference to FIG. 4. Tag assembly 20 consists of an electronic device 21 that may be composed of a circuit board 22 on which a plurality of circuit elements 24, 26 may be mounted. The electronic device monitors the tire by collecting, storing and/or reading at least one engineering condition of the tire. As illustrated, circuit elements 24, 26 are intended to representatively illustrate any number (i.e., more or less that the two representatively illustrated components) of a large variety of electrical components, which components may include sensors of various types and other electronic components including, but not limited to, microprocessors, memory elements, power supplies including one or more batteries, transmitter and receiver devices, antenna elements and other similar components. Sensors may include, but are not limited to, elements and devices for sensing temperature, pressure, tire rotation, and other engineering conditions of the tire in which the tag assembly is mounted. The tag assembly may be designed to monitor the tire in which it is mounted by collecting and storing for later retrieval, any type of tire related engineering data desired and/or other types of tire related data as, for example, manufacturing data including serial number, manufacturing time, date and location, or any other type of relevant data desired to be associated with the particular tire. Following placement of the representatively illustrated components 24, 26 on the printed circuit board 22, the thusly-formed electronic device 21 is encapsulated in a suitable rigid potting material 28 or protected with a conformal coating material to produce the tag assembly 20. The electronic device 21 may be encapsulated by placing the completed device in a half mould and then filling the half mould with potting material such that the potting material fills the mould and flows around the electronic device 21. After the potting material has dried, the half mould may be removed to yield a rigid tag assembly 20 that may then be glued with an adhesive layer 12 directly to the platform 7 of tire patch 1 as illustrated in FIG. 3.

An alternative technique for securing the electronic device 21 is illustrated in FIG. 5. As illustrated in FIG. 5, a rigid housing 30 may be provided fitting with the contour of the electronic device 21. The rigid housing 30 takes the form of a rigid half shell made up of a closed bottom or lower portion 36, side walls 34, 34′and an open upper portion 32. It will be appreciated that, although only two sides wall are designated in FIG. 5, there are, in fact, four such walls completing the structure. The electronic device 21 may then be potted into the rigid housing 30 by filling the rigid housing 30 with a potting material 28 that fills the rigid housing 30 and flows around the electronic device 21. After the potting material 28 has dried, a rigid tag assembly having at least one side made of potting material and other sides a rigid housing is produced which may then be secured to the tire patch 1 by bonding one side of the rigid housing 30 to the platform 7 of the tire patch 1 using an adhesive layer 12. The sequence of assembling the electronic device 21 to the platform 7 of the tire patch 1 may be performed either before or after the tire patch 1 is attached to the inner liner of a tire. In addition, the rigid housing 30 may first be affixed to the platform 7 by way of adhesive layer 12 followed by encapsulation of the electronic device 21 into the rigid housing 30 by potting material 28.

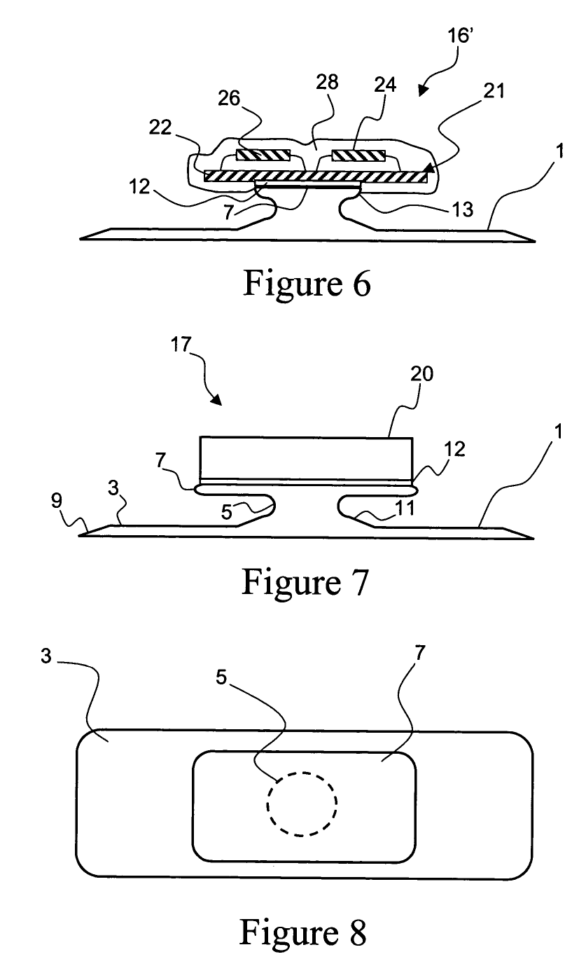

Yet another alternative technique for securing the electronic device 21 to the platform 7 of a tire patch 1 is illustrated in FIG. 6. As illustrated in FIG. 6, the printed circuit board 22 of the electronic device 21 has an upper side fitted with representatively illustrated electronic components 24, 26 and a bottom side. The bottom side of the circuit board 22 is directly bonded to the platform 7 of the tire patch 1 by applying a suitable adhesive 12 between the bottom side of circuit board 22 and the flat rubber platform 7. The circuit board 22 may then be pressed onto the flat rubber platform 7. After bonding the electronic device 21 to the platform 7, the bonded electronic device 21 is covered with a varnish or conformal coating material 28′that may be composed of a composition similar to the encapsulating or potting material 28 previously described. As can be seen from the illustration in FIG. 6, the coating material 28′ is arranged to not only completely cover the electronic device 21 including the circuit board 22 and all components 24, 26, but also to cover at least a portion of the flared edges 13 of the platform 7. The resultant patch assembly 16′ of FIG. 6 may then be secured to the inner liner of a tire using any suitable technique. As with the arrangement illustrated in FIG. 5, the sequence of assembling the electronic device 21 to the platform 7 of the tire patch 1 may be performed either before or after the tire patch 1 is attached to the inner liner of a tire.

A second patch assembly embodiment 17 in accordance with the present subject matter is illustrated in FIGS. 7 and 8. As illustrated, one difference between patch assembly embodiment 17 and the previously illustrated embodiments resides in the elongation of the platform portion 7 of the tire patch 1. As illustrated in FIGS. 7 and 8, the tire patch 1 is provided with a base portion 3 and may be provided with feathered edges 9, a tapered profile 11 and a pillar 5 all corresponding to like features previously illustrated in FIGS. 1 and 2 and all providing similar functions and benefits as previously described. Platform 7, in this embodiment, may be provided as a generally flat, rectangular platform 7 so that the contour of the platform 7 fits within the contour of the tag assembly 20. This configuration of the platform 7 provides an enlarged surface such that adhesive layer 12 may provide a stronger bond between the tag assembly 20 and the platform 7. In this embodiment the pillar 5 may maintain the same circular shape as the embodiments previously illustrated.

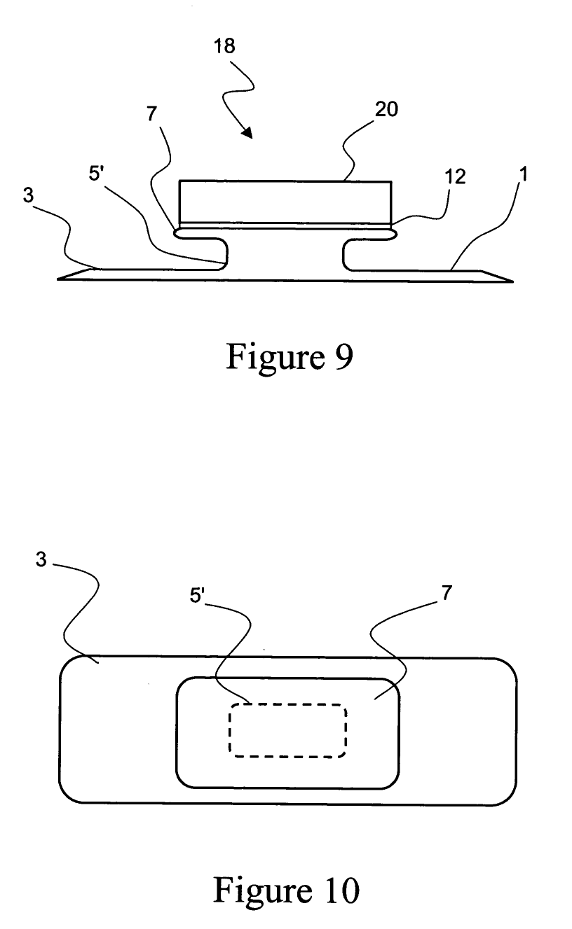

A third patch assembly embodiment 18 of the present subject matter will now be described with reference to FIGS. 9 and 10. The tire patch 1 illustrated in FIGS. 9 and 10 retains every feature and function of the second patch assembly embodiment 18 illustrated in FIGS. 7 and 8 except for the pillar 5. In this embodiment, the pillar 5′ has been configured to have an outer contour shaped like the footprint of the tag assembly 20 and a size at least smaller than the tag assembly footprint. With this configuration of the pillar 5′, the mechanical constraints from the tag assembly 20 are homogeneously distributed to the vulcanized rubber tire patch 1.

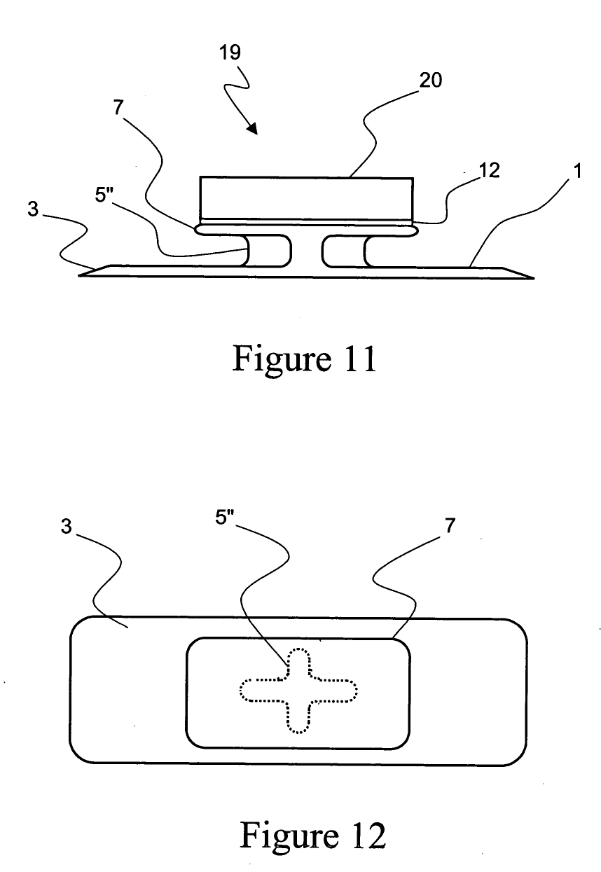

A fourth patch assembly embodiment 19 of the present subject matter is illustrated in FIGS. 11 and 12. As in the previous two embodiments, the tire patch 1 illustrated in FIGS. 11 and 12 retains all of the features previously illustrated except for the pillar. In this embodiment, the pillar 5″ has an outer contour shaped like a cross. It has been found that this cross-shaped contour provides a higher level of rejection of some frequency modes, thus providing improved decoupling of any electronic device 20 which may be affixed to the platform 7 from stress and vibration transmitted to the electronic device 20 from the tire as it comes into contact with a traveled surface.

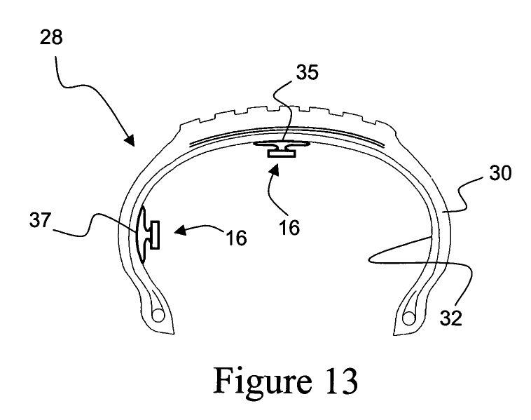

Now with reference to FIG. 13, an exemplary tire assembly embodiment 28 of the present invention is illustrated wherein a patch assembly 16 is mounted within a pneumatic tire 30. Although reference numeral 16 is used here to represent the exemplary patch assembly integrated with pneumatic tire 30, it should be appreciated that any specific patch assembly, including exemplary embodiments 16, 16′, 17, 18, and 19, may be utilized. As shown in FIG. 13, tire 30 includes an innerliner 32. The patch assembly 16 disclosed herein may be mounted at various locations within the pneumatic tire; two of these locations are illustrated at the crown portion 35 of the tire and near the sidewall portion 37. As will be appreciated by those of ordinary skill in the art, the patch assembly 16 may be mounted at any convenient location on the innerliner of the tire, the two locations shown merely being exemplary of such possible mounting locations.

While the present subject matter has been described in detail with respect to specific embodiments thereof, it will be appreciated that those skilled in the art, upon attaining an understanding of the foregoing may readily produce alterations to, variations of, and equivalents to such embodiments. For example, the tag assembly 20 illustratively attached to the tire patch 1 in FIGS. 7, 9, and 11 might just as easily be replaced by the rigid housing 30 configuration illustrated in FIG. 5 or the directly bonded and encapsulated electronic device 21 as illustrated in FIG. 6. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

1. A tire patch for mounting devices inside a tire comprising:
a base portion having an upper portion and a lower portion, the lower portion being configured to be attached to an inner surface of a tire;
a platform portion having an upper portion and a lower portion, the upper portion being substantially flat and configured as a device mounting surface; and
a pillar portion having an upper portion and a lower portion, the upper portion connected to the lower portion of the platform portion and the lower portion connected to the upper portion of the base portion, whereby the tire patch is configured to decouple selected tire related phenomena from any device which may be attached to the upper portion of the platform.

2. The tire patch of claim 1, wherein the platform portion and the pillar portion each have circular cross-sections and wherein the upper portion of the pillar portion has a cross-section smaller than the cross-section of the platform portion and wherein the lower portion of the pillar portion has a tapered profile, whereby mechanical stress conducted between the base portion and the platform portion is uniformly distributed.

3. The tire patch of claim 1, wherein the base portion is generally rectangular with two relatively longer substantially parallel sides and two relatively shorter rounded sides.

4. The tire patch of claim 1, wherein the base portion has peripheral edges that are feathered from the upper portion of the base portion.

5. The tire patch of claim 1, wherein the platform portion and the base portion each have rectangular cross-sections.

6. The tire patch of claim 5, wherein the pillar portion has a rectangular cross-section.

7. The tire patch of claim 5, wherein the pillar portion has a cross-shaped cross-section.

8. A patch assembly for mounting inside a tire comprising:
a base portion having an upper portion and a lower portion, the lower portion being configured to be attached to an inner surface of a tire;
a platform portion having an upper portion and a lower portion, the upper portion being substantially flat and configured as a device mounting surface;
a pillar portion having an upper portion and a lower portion, the upper portion connected to the lower portion of the platform portion and the lower portion connected to the upper portion of the base portion; and
a device secured to the upper portion of the platform portion, whereby the device may be decoupled from selected tire related phenomena.

9. The patch assembly of claim 8, wherein the platform portion and the pillar portion each have circular cross-sections and wherein the upper portion of the pillar portion has a cross-section smaller than the cross-section of the platform portion and wherein the lower portion of the pillar portion has a tapered profile, whereby mechanical stress conducted between the base portion and the platform portion is uniformly distributed.

10. The patch assembly of claim 8, wherein the base portion is generally rectangular with two relatively longer substantially parallel sides and two relatively shorter oval shaped ends.

11. The patch assembly of claim 8, wherein the base portion has peripheral edges that are feathered from the upper portion of the base portion.

12. The patch assembly of claim 8, wherein the platform portion and the base portion each have generally rectangular cross-sections.

13. The patch assembly of claim 12, wherein the pillar portion has a rectangular cross-section.

14. The patch assembly of claim 12, wherein the pillar portion has a cross-shaped cross-section.

15. The patch assembly of claim 9, wherein the device comprises:
a circuit board having an upper portion and a lower portion; and
at least one selected electrical component secured to the upper portion of the circuit board, wherein the lower portion of the circuit board is adhesively bonded to the upper portion of the platform portion of the tire patch.

16. The patch assembly of claim 15, further comprising a conformal coating material covering the upper portion of the circuit board, all electrical components secured thereto, and at least a portion of the lower portion of the platform portion thereby forming a sealed encapsulation of the device.

17. The patch assembly of claim 8, wherein the device comprises:
a circuit board having upper and lower portions;
at least one selected electrical component secured to the upper portion of the circuit board; and
a conformal coating material encasing the circuit board and all electrical components secured thereto.

18. The patch assembly of claim 17, wherein the conformal coating material is a rigid potting material and the device is adhesively bonded to the upper portion of the platform.

19. The patch assembly of claim 18, wherein the contour of the platform portion corresponds to the contour of the device.

20. The patch assembly of claim 8, wherein the device comprises:
a rigid half shell having an open upper portion, side portions and a closed lower portion;
a circuit board having an upper portion and a lower portion and at least one selected electrical component secured to the upper portion of the circuit board, said circuit board positioned within the rigid half shell; and
a conformal coating material sealing said circuit board and said at least one selected electrical component within the rigid half shell;
wherein the lower portion of the rigid half shell is adhesively bonded to the upper portion of the platform portion of the tire patch.

21. A tire assembly with integrated devices, comprising:
a pneumatic tire;
a tire patch comprising:
a base portion having an upper portion and a lower portion, the lower portion being attached to an inner surface of said pneumatic tire;
a platform portion having an upper portion and a lower portion, the upper portion being substantially flat and configured as a device mounting surface; and
a pillar portion having an upper portion and a lower portion, the upper portion connected to the lower portion of the platform portion and the lower portion connected to the upper portion of the base portion; and
a device, said device secured to the upper portion of the platform portion of said tire patch, whereby the device may be decoupled from selected tire related phenomena.

22. The tire assembly of claim 21, wherein the platform portion and the pillar portion each have circular cross-sections and wherein the upper portion of the pillar portion has a cross-section smaller than the cross-section of the platform portion and wherein the lower portion of the pillar portion has a tapered profile, whereby mechanical stress conducted between the base portion and the platform portion is uniformly distributed.

23. The tire assembly of claim 21, wherein the base portion is generally rectangular with two relatively longer substantially parallel sides and two relatively shorter rounded ends.

24. The tire assembly of claim 21, wherein the base portion has peripheral edges that are feathered from the upper portion of the base portion.

25. The tire assembly of claim 21, wherein the platform portion and the base portion each have generally rectangular cross-sections.

26. The tire assembly of claim 23, wherein the pillar portion has a rectangular cross-section.

27. The tire assembly of claim 23, wherein the pillar portion has a cross-shaped cross-section.

28. The tire assembly of claim 21, wherein the device comprises:
a circuit board having an upper portion and a lower portion; and
at least one selected electrical component secured to the upper portion of the circuit board, wherein the lower portion of the circuit board is adhesively bonded to the upper portion of the platform portion of the tire patch.

29. The tire assemby of claim 28, further comprising a conformal coating material covering the upper portion of the circuit board, all electrical components secured thereto, and at least a portion of the lower portion of the platform portion thereby forming a sealed encapsulation of the device.

30. The tire assembly of claim 21, wherein the device comprises:
a circuit board having upper and lower portions;
at least one selected electrical component secured to the upper portion of the circuit board; and
a conformal coating material encasing the circuit board and all electrical components secured thereto.

31. The tire assembly of claim 30, wherein the conformal coating material is a rigid potting material and the device is adhesively bonded to the upper portion of the platform.

32. The tire assembly of claim 31, wherein the contour of the platform portion corresponds to the contour of the device.

33. The tire assembly of claim 22, wherein the device comprises:
a rigid half shell having an open upper portion, side portions and a closed lower portion;
a circuit board having an upper portion and a lower portion and at least one selected electrical component secured to the upper portion of the circuit board, said circuit board positioned within the rigid half shell; and
a conformal coating material sealing said circuit board and said at least one selected electrical component within the rigid half shell;
wherein the lower portion of the rigid half shell is adhesively bonded to the upper portion of the platform portion of the tire patch.

34. A method of mounting a device inside a tire comprising the steps of:
providing a tire;
providing a device;
providing a tire patch having a platform portion with a flat upper surface and a lower surface, a base portion with a flat lower surface and an upper surface and a pillar portion with an upper portion and a lower portion connecting the platform portion to the base portion and configured to decouple selected tire related phenomena from the platform;
attaching the device to the upper surface of the platform portion of the tire patch; and
attaching the lower surface of the base portion of the tire patch to an inner surface of the tire.

35. The method of claim 34, wherein the step of providing a tire patch includes providing the platform portion and the pillar portion each with circular cross-sections wherein the upper portion of the pillar portion has a cross-section smaller than the cross-section of the platform portion and the lower portion of the pillar portion has a tapered profile, whereby mechanical stress conducted between the base portion and the platform portion is uniformly distributed.

36. The method of claim 34, wherein the step of providing a tire patch includes providing the base portion with a generally rectangular cross-section with two relatively longer substantially parallel sides and two relatively shorter oval shaped ends.

37. The method of claim 34, wherein the step of providing a tire patch includes providing the base portion with peripheral edges that are feathered from the upper portion of the base portion.

38. The method of claim 34, wherein the step of providing a tire patch includes providing the platform portion and the base portion each with generally rectangular cross-sections.

39. The method of claim 38, wherein the step of providing a tire patch includes providing the pillar portion with a rectangular cross-section.

40. The method of claim 38, wherein the step of providing a tire patch includes providing the pillar portion with a cross-shaped cross-section.

41. The method of claim 34, wherein the step of providing a device comprises the steps of:
providing a circuit board having an upper portion and a lower portion; and
securing at least one selected electrical component to the upper portion of the circuit board.

42. The method of claim 41, wherein the step of attaching the device comprises the step of adhesively bonding the lower portion of the circuit board to the upper portion of the platform portion of the tire patch.

43. The method of claim 42, wherein the step of attaching the device further includes the step of applying a conformal coating material to the circuit board, all secured electrical components and at least a portion of the lower side of the platform.

44. The method of claim 41, wherein the step of providing a device further comprises the step of applying a conformal coating material covering the upper portion of the circuit board, all electrical components secured thereto, and the lower portion of the circuit board.

45. The method of claim 34, wherein the step of providing a device comprises the steps of:
providing a rigid half shell having an open upper portion, side portions and a closed lower portion;
providing a circuit board having an upper portion and a lower portion and at least one selected electrical component secured to the upper portion of the circuit board;
positioning said circuit board within the rigid half shell; and
applying a conformal coating material sealing said circuit board and said at least one selected electrical component within the rigid half shell.

46. The method of claim 34, wherein the step of attaching the device to the upper surface of the platform precedes the step of attaching the lower surface of the base portion of the tire patch to an inner surface of the tire.

47. The method of claim 34, wherein the step of attaching the lower surface of the base portion of the tire patch to an inner surface of the tire precedes the step of attaching the device to the base portion of the tire patch.
